(19) United States
(12) Patent Application Publication
(10) Pub. No.: US 2009/0195961 A1
(43) Pub. Date: Aug. 6, 2009

(54) METHOD AND DEVICE FOR STORING ELECTRICITY IN QUANTUM BATTERIES

(76) Inventor: Rolf EISENRING, Oberengstringen (CH)

Correspondence Address: NIXON & VANDERHYE, PC, 901 NORTH GLEBE ROAD, 11TH FLOOR, ARLINGTON, VA, 22203, US

(21) Appl. No.: 12/361,892

(22) Filed: Jan. 29, 2009

Related U.S. Application Data
(63) Continuation-in-part of application No. 11/892,353, filed on Aug. 22, 2007.
Application No. 11/892,353 is a division of application No. 10/519,491, filed on Aug. 10, 2005, now abandoned.

(30) Foreign Application Priority Data
Jul. 1, 2002 (CH) 1130/02

(51) Int. Cl. H01G 4/30; H01G 4/32; H01G 4/06

(52) U.S. Cl. 361/301.4; 361/301.5; 361/311

(57) ABSTRACT

Quantum Batteries (super capacitors) which by a new quantum effect “virtual photon resonance” can store electrical energy as a pure electrical battery in ranges up to 15 MJ/kg and more. The battery is basically a capacitor composed of insulating matrix material with either dispersed nanocrystal particles of Rutile TiO₂ or alternating layers of Rutile crystal TiO₂ deposited by Vapor Deposition Process. After reaching the resonance conditions (electrostatic field has suitable 1) strength and 2) energy content) the capacitor becomes a constant voltage battery and takes up additional energy by Dirac current pulses at very fast rates. Thereby the Rutile crystal (semiconductor) changes its state from an insulator to becoming conductive. The battery can be built flat or wound. Voltage from a few to kVolts and top capacities are only limited to mechanical constraints. Due to the nearly zero source resistance the battery loads and discharges at constant voltage and at extremely high rates. Measurements on a first practical Quantum Battery sample shows qualitatively its principal function.

This application is a continuation-in-part of patent application entitled: METHOD FOR STORING ELECTRICITY IN QUANTUM BATTERIES, filed Aug. 22, 2007, which in turn is a division of application Ser. No. 10/519,491, filed Dec. 30, 2004, the entire content of which is hereby incorporated by reference in this application.

This invention relates to high density storage of electrical energy in a device composed of materials with special electrical properties forming a battery as a “super capacitor” or a so-called “Quantum Battery” for usage in stationary as well as mobile applications, and also in applications where rapid loading and discharge of energy is required.

### BACKGROUND OF THE INVENTION

The high specific weight when storing electrical energy in conventional batteries and also in capacitors is one of the major shortcomings for mobile applications. On the other hand, the much more advantageous direct storage of chemical energy in fossil fuels and its ease of utilization led to an unacceptable waste of irrecoverable natural reserves. Furthermore, the technical storage and discharge of electrical energy in, e.g., lead batteries, is bound to a high resistance, which results in high heat losses, which, in turn, strongly limit loading and discharge speeds. Available “super capacitors” function on a different physical principle. They operate only on low voltages, are sensible to mechanical shocks, show some elevated resistances and have several orders of magnitude lower energy and power densities.

### BRIEF DESCRIPTION OF THE INVENTION

The storage device in accordance with an exemplary, non-limiting embodiment of the invention, is independent from a stationary supply source and is therefore utilized to power electrical devices for mobile traffic (road vehicle, train, ship as well as aircraft), and is aimed as an energy substitute for fossil fuels. The high density and substantially resistance- and loss-free storage technology allows also the application in energy supply for household and the transport of energy gained through solar technology. The special materials also allow the manufacture of new types of electronic components. The extreme fast and loss-free discharge of the electrically stored energy at constant voltage enabled by the zero source resistance of the battery allows in extreme cases, explosive discharge of the device in a very short time. This feature can be used in potential applications as explosives.

The new device allows direct storage of electrical energy with a density in the same order of magnitude as energy that can be stored as chemical energy in fossil fuels. Densities in the range of 1 to over 15 MJ/kg can be reached. The special materials of the new storage device allow nearly unlimited loading and discharging cycles, and the material does not wear. During operation, the storage device does not show losses due to resistance. The device is substantially unaffected by mechanical shock or excessive accelerations as well as extreme temperatures. Also any positioning in space is irrelevant to its operation.

Accordingly, in one exemplary and non-limiting aspect, there is provided a capacitor or a storage battery comprising: a compound film comprising an isolated metal foil and a polymer foil, the compound film coated with a mixture of ground crystal grains embedded in an insulating polymer resin matrix wherein the crystal grains comprise chemically dipolar, Rutile-phase nano particles.

### DESCRIPTION OF THE FIGURES

FIG. 1a: Condition is shown of Quantum Battery in the state of a capacitor.

FIG. 1b: Condition is shown of the Quantum Battery when photon resonance is occurring and battery charge is flowing onto the device.

FIG. 1c:Condition is shown when the Quantum Battery has been charged with a first battery charge.

FIG. 2: Showing circuit for Quantum Battery current measurement and schematic construction of the different parts and layers of the actual Quantum Battery under test.

FIG. 3a: Showing graph of actual measurements during discharging of the Quantum Battery, as a function of time.

FIG. 3b: Showing schematic outline of the graph of the actual measurement of FIG. 3a.

### DETAILED DESCRIPTION OF THE INVENTION

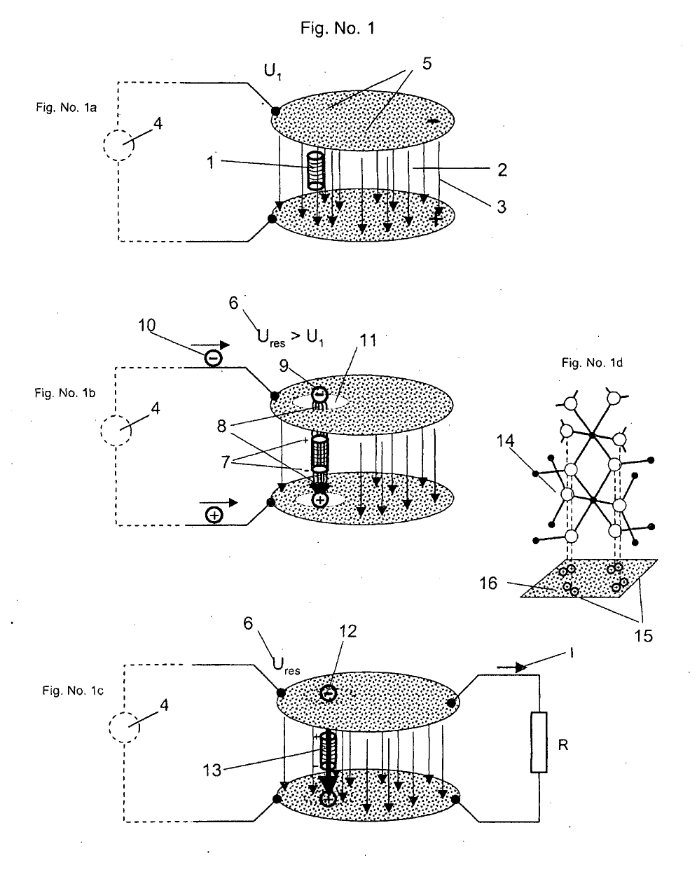

The following description refers to the FIG. 1. whereas FIG. 1a shows the condition of the quantum battery as a capacitor, FIG. 1b during the charging process, FIG. 1c as a charged battery and FIG. 1d explains the charging effect at the example of a TiO₂ Rutile crystal structure. The invention is based on the physical effect that very small particles, denominated with (1), of a strong dipolar crystal material such as TiO₂ Rutile (strong electro negativity; see Linus C. Pauling, The nature of Chemical Bonds J. Am. Chem. Soc 1932) embedded in an insulating matrix (2), e.g., SiO₂ or polymer resin, are exposed to an electrostatic field (3), whereas the device is constructed in such a way that the insulating matrix is stressed by a field far below its critical break down point and the crystal material is stressed above its dielectric strength (>about 5 kV/mm). The Fermi energy level (5) remains constant over the whole electrode. The voltage applied from the power source (4) on the device is then slightly increased to the point (6) where the energy content of the local field in eV (=e·Uᵣₑₛ) is equal to the energy potentially required to lift and hold all valence electrons of the valence molecular orbitals (V-MO, see Linus Pauling (1928). London's paper. General ideas on bonds. Oregon State University Libraries Special Collections) of one molecular row of the Rutile crystal from the valence to the conduction energy band (7).

Due to strong local inhomogeneities (8) appearing during very short times in the electrostatic field when considering the alternative nature of the field (see Richard P. Feynman, The Feynman Lectures on Physics, Cal. Tech 1964; Stevens W. Hawking, A brief History in Time 1988, Bantam Bell Publishing Group etc.) as an entity of exchanging virtual particles (photons), it is statistically possible that equally long molecule rows (same voltage), become energized, row after row. The virtual particles are momentarily concentrating their energy exchange locally on the matching crystal row, similar to a conventional resonance (virtual photon resonance). The extremely focused inhomogeneous electrical field hence concentrates the local sheet charges to one single full charge and holds it isolated in a fixed position (9). For each energized crystal row, an additional electrical charge (10) is flowing onto the capacitor at constant voltage Uᵣₑₛ (6) in the form of a Dirac current pulse and filling the density hollow in the Fermi energy level (11) caused by the shortly appearing inhomogeneity of the electrical field. Each molecular crystal row of equal length requires the same amount of eV (6). With this inflow of electrical charges at constant voltage, the battery will be loaded (12). The process repeats until all matching crystal rows are energized respectively charged. The charges remain in their fixed positions held by extremely focused fields (13) supported by their anti-parallel spins or equivalently said the isolated and fixed positioned charges maintain the strongly focused fields; although this effect the inventor has coined “virtual photon resonance” it could also be named “super polarization”. When fully in resonance one TiO₂ Rutile crystal lattice structure (14) with a crystal structure base line (15) of 0.4594 nm can contribute with 8 electrons (12) thus arriving at a sheet charge density of 6.07 As/m² (16). And depending on the dielectric strengths of the materials several layers or crystal rows (1) can be packed in one Quantum Battery each of those contributes with an additional sheet charge unit. The total stored energy is thus equal to total charge multiplied by Uᵣₑₛ.

Contrary to the loading of a capacitor where each charge will increase the voltage

$$( Δ u = \frac{1}{C} \cdot Δ q ) ,$$

any additional charge flowing onto the battery will not increase the voltage. When charging the battery, no energy will be dissipated contrary to as it is in the case for a capacitor, where only 50% will eventually arrive on the capacitor, and exactly 50% of the supplied energy from the external voltage source will be dissipated for building up the electrostatic field

$$( Δ W = 1 / 2 \frac{Δ {Q}^{2}}{C} ) ,$$

and this independent of any resistance. This half part of the input energy is eventually lost as heat. Thus the energy the device is containing as capacitor as to FIG. 1a, is

W=½U₁Q₁=½U₁²C

and after the device becomes a battery as shown in FIG. 1c the device stores then the energy as

$$W = 1 / 2 {U}_{res} {Q}_{res} + {U}_{res} \cdot {\sum }_{n} e$$

The battery operates as a pure electrical battery. Yet the battery is physically at any time an integral part of the physical capacitor.

The outflow of the electrical charges when discharging the battery happens also at constant voltage (6) until the battery is completely empty, respectively all molecular crystal rows of equal length are de-energized. In FIG. 1c the circuit is illustrated, where R indicates the consumer and the current I is calculated from I=Uᵣₑₛ/R. Because the voltage (6) remains constant during any rate of the current outflow, the source resistance of the battery is zero, and it therefore can be discharged at extremely high rates. As soon as the battery is completely empty all the molecular crystal rows are de-energized then the electrical characteristic as a battery disappears and the underlying capacitor becomes fully reactivated in accordance with FIG. 1a.

### Practical Outline of the Device

The storage crystals such as TiO₂, SrTiO₃ or similar, either ground to grains of some nanometer (nm) size or as nm-thick layers, are applied together with an insulating medium on a carrier surface. There exists a particular prerequisite for a type of crystal, known as a “Rutile” phase crystal.

### Two Different Processes are Possible:

a) A mixture of ground crystal grains and polymer resin are first dispersed and then electrostatically sprayed on a compound film composed of a metal and a polymer foil, which is either continuously laid on a flat table or wrapped around a tube-type mandrel. The isolated metal foil of the compounded film is the counter electrode. Due to the insulating resin and the compound film, the electrical charges arriving with the wet resin on the surface cannot flow to ground. These charges, together with the metal foil, create a very strong electrical field, which exerts by means of the capacitive effect, very strong surface forces. These surface forces cause geometrically exact forms, and in the case of the mandrel, exact round layers of extremely accurate thickness. In addition, due to the strong surface forces, a high hydraulic pressure in the wet resin is applied so that the layers become air pore-free. Additionally, the strong electrostatic field causes a proper alignment of the dipoles. The resin is then cured by heat or radiation. Thereafter the layered film is cut and formed into a multi-layer capacitor. The cut films can either be arranged flat or wound up. Finally, the metallic parts of the device are alternatively electrically connected forming the positive and negative poles of the storage device.
b) By means of Chemical Vapor Deposition (CVD) or Physical Vapor Deposition (PVD) several thin layers of the storage crystals, e.g., TiO₂, are deposited alternatively together with insulation layers, e.g., SiO₂ or Al₂O₃, on a planar carrier surface which itself is covered by a conductive material such as, e.g., platinum, or a silicide forming the bottom electrode. Through proper annealing at a temperature of, e.g., 700° C., polycrystalline layers are achieved. After deposition of each resonance layer, it becomes a fully sandwich-type structure, covered by an overlapping insulator layer that also provides fixation. Thus, after the subsequent annealing process above 800° C. for achieving the Rutile phase, and when cooling down, the resonance layers do not delaminate even though they have strongly different thermal expansion coefficients. Finally, a metallic cover layer is placed forming the top electrode of the device. It is also possible to deposit several combinations of layers.

Eventually, the storage device will be coated by an isolating material and the electrodes connected to external clamps or through strip lines to the control logic.

Storage units can be build for operating voltages from a few Volts up to several kV depending on the technical feasibility of fabricating of maximal crystal lengths. The storage capacity and overall dimensions of the device are only limited by mechanical constraints.

### Real Actual Sample and its Measurements

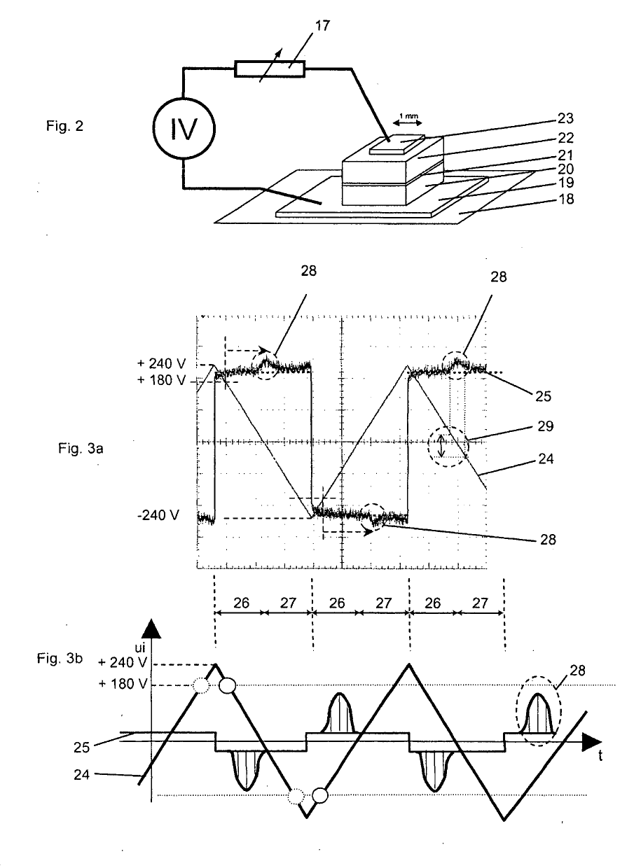

FIG. 2 depicts the composition of a quantum battery sample, which is produced in a MIS-architecture (metal-isolator-semiconductor) and on a silicon wafer (18). It consists of a bottom electrode (19) of a n+ silicide, a 300 nm thick SiO₂ isolation layer (20), a central 15 nm thick TiO₂ layer (21) of a pure Rutile crystal, deposited in MOCVD technique at 450° C. and post annealed above 850° C., a further 300 nm thick isolation layer (22) of SiO₂ and topped by an Titanium electrode (23). In the practical sample the layers (20) and (22) are overlapping and totally enclosing the layer (21). The top electrode has been structured in 1 mm×1 mm patches so that each shows a capacitance of about 60 pF.

In FIGS. 3a and 3b are shown the actual measurements and in FIG. 2 the schematic outline of the IV test arrangement where a triangular voltage of ±15000 V/s and ±240 V amplitude at 15 Hz has been applied to the sample. Thus the resulting current signal shows basically a rectangular form (25) as demanded by a capacitor. The power supply acts as an energy supplier during the charging phase (27) and as load for the quantum battery during the discharging phase (26). The quantum battery is a constant voltage source and therefore in the case of imposing a higher voltage from an external source it will short circuit this external source until itself is completely loaded and vice versa in the case of discharging by the external source (now this a load) will itself be short-circuited. But due to the extreme fast loading process no short circuits currents can be seen during charging of the quantum battery however during discharge the discharge current can easily be seen in area (28). The outflow of the battery charges at a forced constant voltage simulates a sudden increase of the capacitance C=ΔQ/ΔU(ΔU→0) that causes a strong dynamic phase shift of about 78° respectively 89° of the discharge currents. Between 150 V to 210 V additional electrical charges flow onto the battery by individual current pulses (Dirac pulses) at extreme high rates. With the regulator (17) the charging current to the quantum battery can be controlled and for this measurement the value was set to 4.75 kΩ, which limits the charging flow already strongly. Full flow is reached when this value is set to zero Ω. Below of about ±150 V the capacitor shows the typical current performance where also the discharge currents (28) disappear and above this voltage it changes to become a battery. All TiO₂ crystal molecule stacks of same length discharge at same voltage level. This voltage level will be held fixed until the complete battery emptying and in doing so the current peaks increase in size depending on the down slope speed of the imposed external voltage. The area designated with (29) represent the range where the super capacitor can be operated as a constant voltage battery, which amounts to about 60 V. This value betrays that the length of the Rutil crystal rows respectively the thickness of the layer vary from about 11 nm to 19 nm with average at 15 nm equal to about 180 V. The actual measurements in FIG. 3. a clearly depict that no loading current to the quantum battery can be detected in the feeding line. This current consists of immeasurable extreme fast electrical pulses, nevertheless a large quantity of energy is continuously flowing onto the quantum battery during a very short time period, hence without measurable loss thus indicating that the input resistance of the battery is extremely small, if not zero.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A capacitor or storage battery comprising:
a compound film comprising at least one layer of an isolated metal foil and a polymer foil, the compound film coated with a mixture of ground crystal grains embedded in an insulating polymer resin matrix wherein said crystal grains comprise chemically dipolar, Rutile-phase nano particles.

2. The capacitor or storage battery of claim 1 wherein a first of said coated compound film forms the positive pole and a second of said coated compound film forms the negative pole of the capacitor.

3. The capacitor or storage battery of claim 1 wherein said crystal grains comprise TiO₂ in the form of the Rutile phase.

4. The capacitor or storage battery of claim 1 wherein said capacitor or storage battery is flat.

5. The capacitor or storage battery of claim 1 wherein said capacitor or storage battery is wound.

6. The capacitor or storage battery of claim 1 wherein said compound film is combined with similar compound films in multiple layers.

7. The capacitor or storage battery of claim 1 wherein said chemically strong dipolar crystals which are separated by an electrically isolating material store the electrical energy by the effect of the virtual photon resonance.

8. The capacitor or storage battery of claim 1 wherein said dipolar crystal grains due to local inhomogeneities of the electrical field which are occurring across theses crystal grains during very short times these grains become conductive thereby taking up energy by a flow of electric charges onto the storage battery composed of very fast current pulses of the Dirac form from an external power source.
